(19) United States
(12) Patent Application Publication
(10) Pub. No.: US 2012/0315610 A1
(43) Pub. Date: Dec. 13, 2012

(54) International Alphabet Board and Method for Learning Languages with the Same

(76) Inventor: Daniel Listim, Philadelphia, PA (US)

(21) Appl. No.: 13/482,013

(22) Filed: May 29, 2012

Related U.S. Application Data
(60) Provisional application No. 61/495,368, filed on Jun. 9, 2011.

(51) Int. Cl. G09B 1/36

(52) U.S. Cl. 434/171

(57) ABSTRACT

An alphabet board designed to facilitate learning one of several languages includes pockets organized in rows on the front side of the board with each pocket bearing a removable letter of the chosen language and made to receive a set of letter cards bearing a letter matching the letter on the pocket. An area on the front side of the board is designed to receive and display letter cards pulled and placed to spell at least one word in the language. The board further includes pockets for larger diacritical cards which may be placed behind respective letter cards in words to enable reading the diacritical mark and the letter at the same time. Picture cards for each letter of the alphabet are also included for forming words and/or sentences with a picture on the front and a word on the back describing the picture and starting with the respective letter.

### CROSS-REFERENCE TO RELATED APPLICATION

This application claims the benefit of the priority date of earlier filed U.S. Provisional Patent Application Ser. No. 61/495,368, filed Jun. 9, 2011 for Daniel Listim, incorporated herein by reference in its entirety.

### BACKGROUND OF THE INVENTION

Young children pick up language skills in various ways. Many learn a native language hearing it in the home while others learn it in social settings with friends before even attending school. However, in a bilingual home a child may not hear the same language at home as she or he hears at school. Many countries of the world teach children how to read and write English in school. Yet many students still struggle with basic spelling skills up through high school and beyond. Early mastery of at least one language is critical for success in today's competitive world.

Learning a language is largely a repetitive process taking many hours of concentrated effort. Some teach word recognition through rote memorization. Still others teach a phonetic approach by learning to sound out a word. While both approaches may eventually yield results, students may learn best when given the opportunity to interact with a subject through many different forms of media.

However, in today's world of pervasive electronic media, children often miss the opportunity to interact on a tactile level in their educational studies. While computer games offer great flexibility for learning, the teaching method remains largely one of a mouse pointer, arrow keys and an electronic screen. What is lacking is the chance for a child to learn letters forming words and sentences in a tactile manner with a mentor and/or class mates in an interactive setting.

### SUMMARY OF THE INVENTION

An alphabet board designed to facilitate learning a language is disclosed herein. The disclosure includes a rectangular shaped board comprising a front side and a backside and a hanger disposed on the board to hang the board from or on its backside or another side thereof. The disclosed board also includes a plurality of pockets organized in rows and/or columns on the front side of the board, with each pocket bearing one letter in a chosen alphabet. Each of the pockets is made to receive a set of letter cards and/or diacritical cards with each to card bearing a letter matching the letter on the pocket. The board additionally includes an area on the front side of the board made to receive and display a plurality of letter cards sufficient to spell a word in the language. The pocket letters are placed from left to right and from top to bottom for most languages starting with the first letter of an alphabet and proceeding to the last letter of the alphabet. The disclosed board may further include diacritical cards and pockets for the diacritical cards. The board may further comprise a picture card for each letter of the alphabet, each picture card comprising a picture on the front of the card and a word for the picture starting with the respective letter printed on the back of the picture card. The alphabet board may further include at least one longitudinal or vertical slot on the front side of the board, where the slot is designed to receive a plurality of letter cards and/or diacritical card(s) to form at least one word in the language.

A method for learning a language from an alphabet board is also disclosed herein comprising pulling a letter card from a pocket labeled with a specific letter, placing the letter card on an area of the board made to receive at least one letter and picking and placing a plurality of subsequent letters onto the board enough times to form at least one word from the letters. The method also includes placing a diacritical card behind a respective letter card so that one may read the diacritical mark and the letter at the same time. The method may additionally include pulling a picture card from a box or a pocket labeled with a specific letter, the word for the picture starting with the letter on the front of the letter pocket. The method further includes pulling a letter card from a pocket labeled with the starting letter, placing the letter card on one of a row configured to receive the letter and picking and placing a subsequent letter onto the row enough times to form the word for the picture card from the letters.

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1 is a depiction of a Latin alphabet board for learning the English language in accordance with an embodiment of the present disclosure.

FIG. 2 is a depiction of a French alphabet board for learning the French language in accordance with an embodiment of the present disclosure.

FIG. 3 is a depiction of a German alphabet board for learning the German language in accordance with the present disclosure.

FIG. 4 is a depiction of a Swedish alphabet board for learning the Swedish language in accordance with an embodiment of the present disclosure.

FIG. 5 is a depiction of a Portuguese alphabet board for learning the Portuguese language in accordance with an embodiment of the present disclosure.

FIG. 6 is a depiction of a Spanish alphabet board for learning the Spanish language in accordance with an embodiment of the present disclosure.

FIG. 7 is a depiction of an Italian alphabet board for learning the Italian language in accordance with an embodiment of the present disclosure.

FIG. 8 is a depiction of a Dutch alphabet board for learning the Dutch language in accordance with an embodiment of the present disclosure.

FIG. 9 is a depiction of a Russian alphabet board for learning the Russian language in accordance with an embodiment of the present disclosure.

FIG. 10 is a depiction of a Ukrainian alphabet board for learning the Ukrainian language in accordance with an embodiment of the present disclosure.

FIG. 11 is a depiction of a Hebrew alphabet board for learning the Hebrew language in accordance with an embodiment of the present disclosure.

FIG. 12 is a depiction of a letter card front and back in accordance with an embodiment of the present disclosure.

FIG. 13 is a depiction of a picture card front and back in accordance with an embodiment of the present disclosure.

FIG. 14 is a flow chart of a method for learning a language from an alphabet board in accordance with an embodiment of the present disclosure.

FIG. 15 is a flow chart of a method for forming words and sentences from an alphabet board with picture cards in accordance with an embodiment of the present disclosure.

FIG. 16 is a flow chart of a method for transforming an alphabet board in one language into an alphabet board in another language in accordance to with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the claims.

The International ABC board may serve as a primary teaching tool utilized by Pre-school and Elementary school teachers to introduce the letters of the alphabet. The Board may also serve in teaching students the shapes, names and sounds of each letter. The identification of each letter is practiced as the student or child may easily pull the letter card from each pocket and insert it into a wooden ledge on the board below. Hand eye coordination is developed thereby.

Beyond letter recognition, the student may begin to form words, as the sounds of the letters become more familiar. In this way, the International ABC board may be used as a primary tool for reading. The disclosed board teaches both the visual and tactile learner. The presence of the board in the classroom or the home allows for visual emphasis on a chosen alphabet. The activity of touching the cards and placing them on the ledges engages the senses. In an embodiment of the present disclosure, students may also learn a language from pulling and placing letter cards with raised letters.

A main feature of the board is educational and recreational usage. The product teaches the alphabet, spelling and vocabulary in a fun way for 3-7 year old children. Studies have shown that a child's early years up to 6 years of age are critical for language acquisition. This board is simple and easy to use and does not require any computer skills to operate. The board does not require battery or AC (alternating current) power and therefore may be used anywhere and under any circumstances in all countries throughout the world, largely regardless of economic conditions.

The user of the board may often be a child who assembles words by picking or pulling the letters from the pockets and resting them on a small and safely made ledge that is attached to the board beneath the letter pockets. Words and sentences can be arranged on the ledges to facilitate reading and spelling practice. At the end of each assembled word or sentence the child may return every letter to the respective pocket in alphabetical order and thereby learn the relative placement of a letter in the chosen alphabet. The design therefore encourages organizational skills. By returning the letter to its respective pocket, the child's knowledge of the letters is reinforced by repetition.

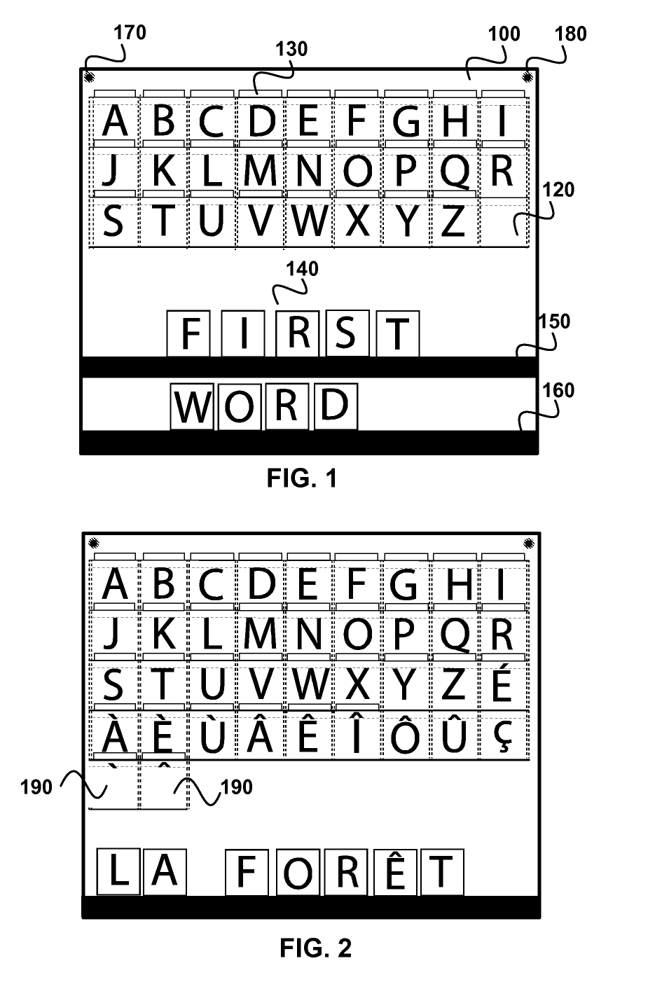

FIG. 1 is a depiction of a Latin alphabet board for learning the English language in accordance with an embodiment of the present disclosure. The English language alphabet board 100 comprises pockets 120 organized in rows, letter cards 130 inserted in sets of up to 10 cards each in a pocket and a common area on the face of the board for placing letter cards pulled from the pockets to form words. Two ledges 150 and 160 may be disposed on the board in the common area in order to hold the letter cards for display. A left hanger 170 and a right hanger 180 are placed on the board to enable it to hang from a wall or a podium or any other furniture in the home or classroom.

The disclosed board designed and made for a classroom setting measures approximately 32″ wide by 27″ high. Three lines of nine pockets each with letters printed or disposed on each pocket may contain up to 10 letter cards. Beneath the rows of pockets are two long holding strips on which the letter cards may be placed to display the formation of letters in spelling words and eventually simple sentences. Punctuation cards are also comprised in an embodiment of the disclosure. Punctuation cards may comprise a colon, semicolon, comma, period, question mark, quotation marks, parenthesis and the like.

Each letter card measures approximately 3″ wide×4″ high. Capital letters on the front face of the cards measure approximately 1.8″ wide by 3″ tall. Lower case letters may be printed or disposed on the back face of the cards. Pockets for the letter cards measure approximately 3.25″ wide by 3.5″ high allowing the cards to extend beyond the pocket height. Where appropriate, letter cards featuring diacritical marks may be included in the card deck. The diacritical cards measure approximately 4.5″ tall for class-use, 4″ for home-use and may be placed behind the Latin letter-cards along the ledge. The wooden ledge on which the letter cards rest measures approximately 1.5″ wide by 32″ long, and is approximately 0.650″ thick. A slot on the top of each ledge made to receive the bottom edge of the letter cards measures approximately 0.5″ deep by 0.10″ wide and is cut at an angle of 20 degrees from the board. Along the top edge of the board is a sleeve to slide 1.5″ wide ⅜ thick plywood for hanging purposes. The board may hang from a belt attached one foot from the center on both sides of the sleeve.

In a home use embodiment of the disclosure, the board measures approximately 23″ wide by 25.5″ high. Three or four lines of nine pockets as needed for a chosen language with letters printed on each pocket may contain up to 10 letter cards each. Each card is approximately 2″ wide by 3.5″ tall. Capital letters painted, printed or embossed on each card measure approximately 1.5″ wide by 2.5″ tall. Beneath the rows of pockets are two long strips on which the letter cards may rest to display the formation of letters in words and eventually sentences. Pockets for the letters therefore measure approximately 2.25″ wide by 3″ high. Each of the wooden ledges on which letters or words may stand measures approximately 1.5″ wide by 23″ long, and are 0.65″ thick with a slot on the top measuring 0.5″ deep, 0.10″ wide and cut at an angle of 20 degrees to the face of the board. Along the top edge of the board is a sleeve to slide 1.5″ wide ⅜″ thick plywood for hanging purposes. A single magnetic hook may also be included for hanging the board from a metallic surface or a metallic podium.

The alphabet board may be covered with cloth, a material or a substance having a color such as sky blue chosen to calm the user of the board and to convey to the user a calm and safe environment for learning. The alphabet board may further comprise a set of letter cards in at least one other language, a set of pocket letters in the other language, and a set of picture cards in the other language. Therefore, a fourth row of pockets may be attached to the board for learning languages having more letters in the alphabet. An embodiment of the disclosed alphabet board further comprises letter cards and pockets with raised letters for tactile learning of a chosen language. The pockets, cards and letters where appropriate, may also be comprised of a cloth composition, a paper composition, a plastic composition and any other composition having some flexibility and structural memory.

The disclosed board may be produced in Latin, Cyrillic & Hebrew letters. Necessary additional letters or diacritical marks may be added to the Latin alphabet for French, German, Spanish, Portuguese and Swedish. Necessary additional letters may also be added to Cyrillic alphabet for Ukrainian. Therefore, larger alphabets with diacritical marks may require four lines of pockets instead of three. The board design is depicted herein for English, French, German, Swedish, Portuguese, Spanish, Italian, Dutch, Russian, Ukrainian and Hebrew. However, the board may also be made in all other languages throughout the world as explained further below.

FIG. 2 is a depiction of a French alphabet board for learning the French language in accordance with an embodiment of the present disclosure. Reference numbers similar to those used in FIG. 1 may be used to identify similar or same elements in the present figure. Additionally, diacritical mark cards 190 comprise only a diacritical mark that may be combined with a respective letter card to form a diacritical letter in accordance with an embodiment of the present disclosure.

A diacritical mark may include marks above a letter, below and within a letter according to all known languages in the world. A diacritical mark may include accent marks, dots, rings, vertical lines, macron or horizontal lines, overlays, curves, curls and double marks as necessary in any known language.

In an embodiment of the disclosure, a plurality of transparent cards and a plurality of pockets for the transparent cards are included. The transparent cards may bear one of a non-transparent diacritical mark and a punctuation mark. The transparent cards may be configured to overlay a letter card and provide one of a diacritical mark and a punctuation mark. Dimensions of a transparent card may therefore be equal to or less than the dimensions of a letter card.

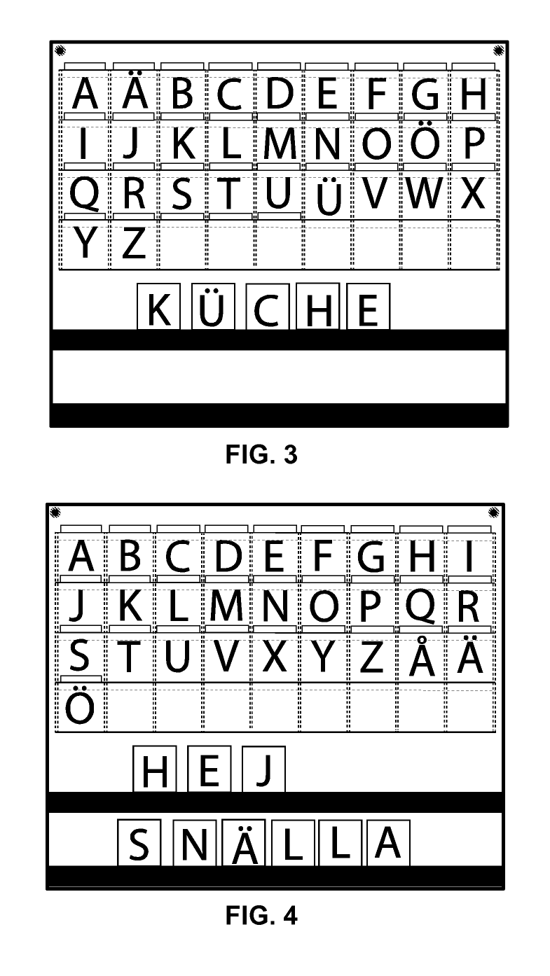

FIG. 3 is a depiction of a German alphabet board for learning the German language in accordance with the present disclosure. Reference numbers similar to those used in FIG. 1 may be used to identify similar or same elements in the present figure.

FIG. 4 is a depiction of a Swedish alphabet board for learning the Swedish language in accordance with an embodiment of the present disclosure. Reference numbers similar to those used in FIG. 1 may be used to identify similar or same elements in the present figure.

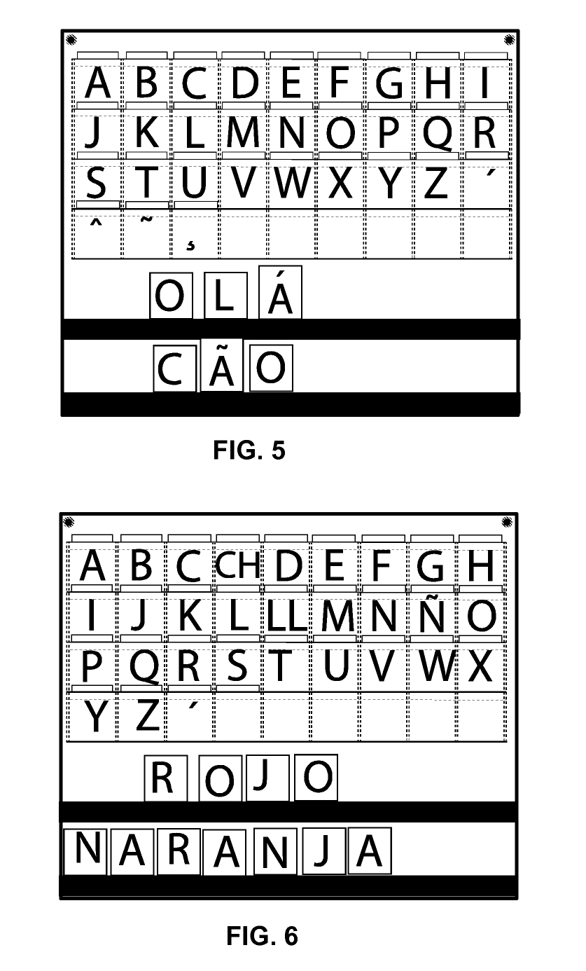

FIG. 5 is a depiction of a Portuguese alphabet board for learning the Portuguese language in accordance with an embodiment of the present disclosure. Reference numbers similar to those used in FIG. 1 may be used to identify similar or same elements in the present figure. A diacritical card is placed behind or over each of the letter ‘A’ cards placed on the top and bottom ledges. Because the diacritical cards are taller than the letter cards, the diacritical is visible above the letter ‘A’ in both instances. Therefore, the diacritical cards may also be placed below any letter card as required to form a Portuguese word on either ledge. The cards may therefore be configured to temporarily adhere to each other to enable a relative placement below or above each other.

FIG. 6 is a depiction of a Spanish alphabet board for learning the Spanish language in accordance with an embodiment of the present disclosure. Reference numbers similar to those used in FIG. 1 may be used to identify similar or same elements in the present figure. Letter cards may bear double letters such as ‘ch’ or ‘ll’ or single letters as shown and required by any particular alphabet. Also, though depicted in upper case, letter cards and pocket letters may comprise small and upper case characters in an embodiment of the disclosure.

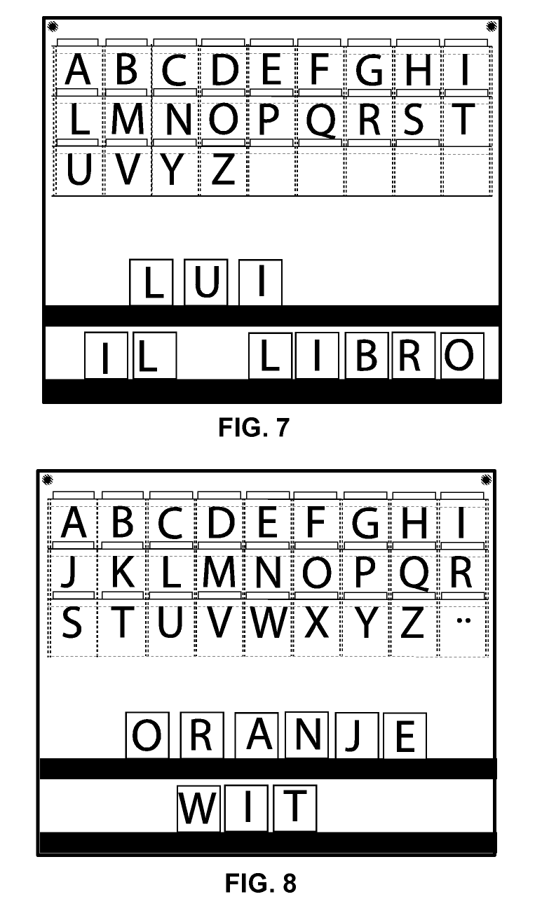

FIG. 7 is a depiction of an Italian alphabet board for learning the Italian language in accordance with an embodiment of the present disclosure. Reference numbers similar to those used in FIG. 1 may be used to identify similar or same elements in the present figure. The Italian alphabet uses a subset of the English alphabet. Therefore, in an embodiment of the disclosure extra English letters may be removed from the pockets of the board depicted in FIG. 1 allowing the English board to be used in learning Italian. The remaining pocket letters may be removed and rearranged on contiguous pockets to form the board as depicted in FIG. 7. To facilitate the rearranging of pocket letters in the embodiment, hook and loop complementary materials and the like may be used on the pocket and the pocket letter. However, pocket letters may otherwise be painted, embossed or printed on the pockets and be erasable or permanently fixed thereon.

FIG. 8 is a depiction of a Dutch alphabet board for learning the Dutch language in accordance with an embodiment of the present disclosure. Reference numbers similar to those used in FIG. 1 may be used to identify similar or same elements in the present figure. Embodiments where a number of pockets required for one language are common with another may take advantage of rearranging or adding pocket letters. In such embodiments, a single board as disclosed may be used for multiple languages. For example, the Dutch alphabet may be comprised in three rows of 9 pockets each and therefore with changing the labeling or printing of just one pocket may be used for both the English and the Dutch languages given respective letter card decks.

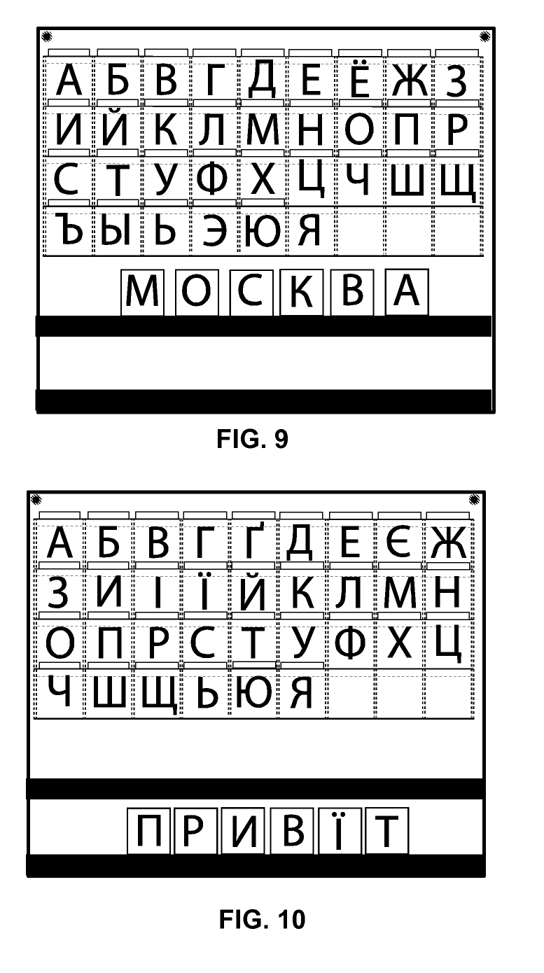

FIG. 9 is a depiction of a Russian alphabet board for learning the Russian language in accordance with an embodiment of the present disclosure. Reference numbers similar to those used in FIG. 1 may be used to identify similar or same elements in the present figure.

FIG. 10 is a depiction of a Ukrainian alphabet board for learning the Ukrainian language in accordance with an embodiment of the present disclosure. Reference numbers similar to those used in FIG. 1 may be used to identify similar or same elements in the present figure.

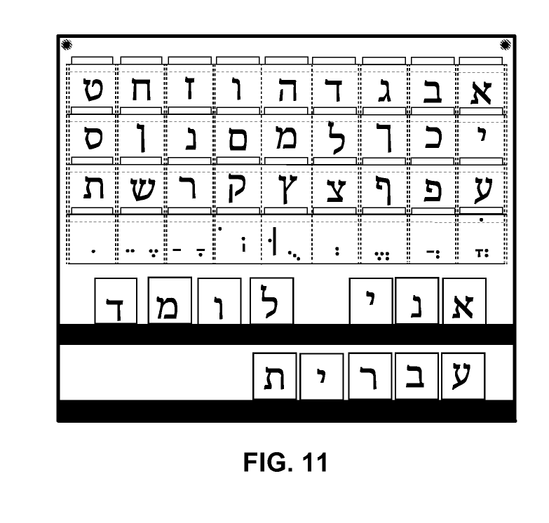

FIG. 11 is a depiction of a Hebrew alphabet board for learning the Hebrew language in accordance with an embodiment of the present disclosure. Reference numbers similar to those used in FIG. 1 may be used to identify similar or same elements in the present figure.

The Hebrew alphabet board may comprise three rows of pockets filled with 27 Hebrew consonants. The fourth row may contain the Hebrew vowels. Two wooden ledges near the bottom of the board are included for resting letter cards pulled from the pockets. Most vowels in Hebrew are expressed in diacritical marks that sit under the consonant. The card showing the diacritical mark for each vowel measures approximately 3″ wide and will hold the letter card measuring 2.75″ wide inside of it. Hebrew letter cards measure approximately 2.75″wide by 4″ high. The vowel letter cards measure approximately 3″ wide by 4″high. Since most writing in Hebrew is done with consonants only, inclusion of the vowels on the board may be for teaching purposes only.

The Hebrew picture cards measure approximately 5″ wide by 7″ tall. On each card is a picture of a basic vocabulary word for children, such as animal, fruit, vegetable, house, family, boy, girl, finger, nose, ear etc. In an embodiment of the present disclosure, the picture and letter cards may be stored in a box measuring 5.25″ by 7.25″ by 0.5″. The card box and the board may be stored or transported in a larger inclusive bag, package or box.

To help a child learn how to spell in the chosen language, a teacher or parent may place a picture card on the ledge and the child assembles a word accordingly. The letters on the pockets may be removed and replaced with letters of a different language where appropriate. An embodiment of the alphabet board includes the pocket letters placed from left to right and from top to bottom starting with the first letter of an alphabet and proceeding to the last letter of the alphabet. However, languages reading from right to left and from bottom to top may use alternate pocket letter placements. The alphabet board may further include at least one longitudinal or vertical slot on the front side of the board, where the slot is designed to receive letter cards to form at least one word in the language. Languages reading from top to bottom may use vertical slots for letter card placement and display.

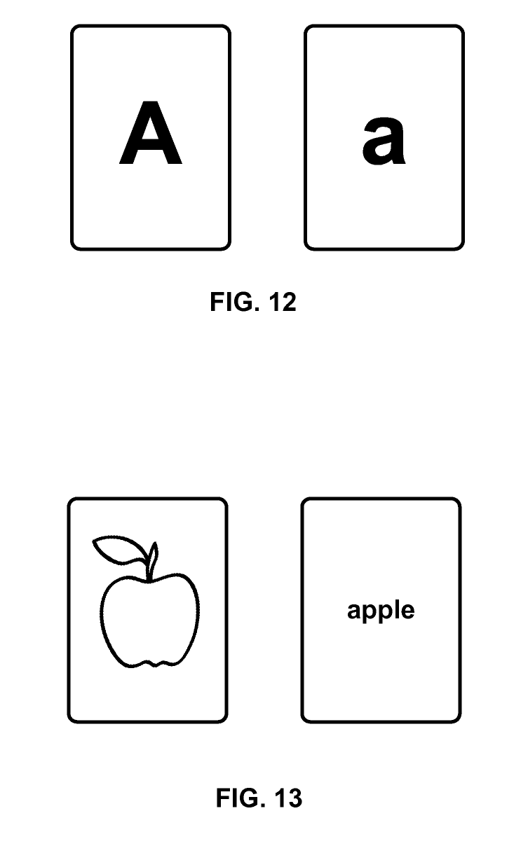

FIG. 12 is a depiction of a letter card front and back in accordance with an embodiment of the present disclosure. The alphabet board may further include a picture card for each letter of the alphabet and at least one area on the board or slot to receive the card. Picture cards may include a picture on the front and a word for the picture starting with the respective letter on the back. The front side of the letter card on the left of FIG. 12 may display a capital letter from the chosen alphabet. The backside of the same letter card on the right of FIG. 12 may display the lower case letter of the respective capital letter.

FIG. 13 is a depiction of a picture card front and back in accordance with an embodiment of the present disclosure. The front side of the letter card on the left of FIG. 13 may display a picture of an object starting with a letter of the chosen alphabet. The backside of the same letter card on the right of FIG. 13 may display a word describing the picture on the front side of the card.

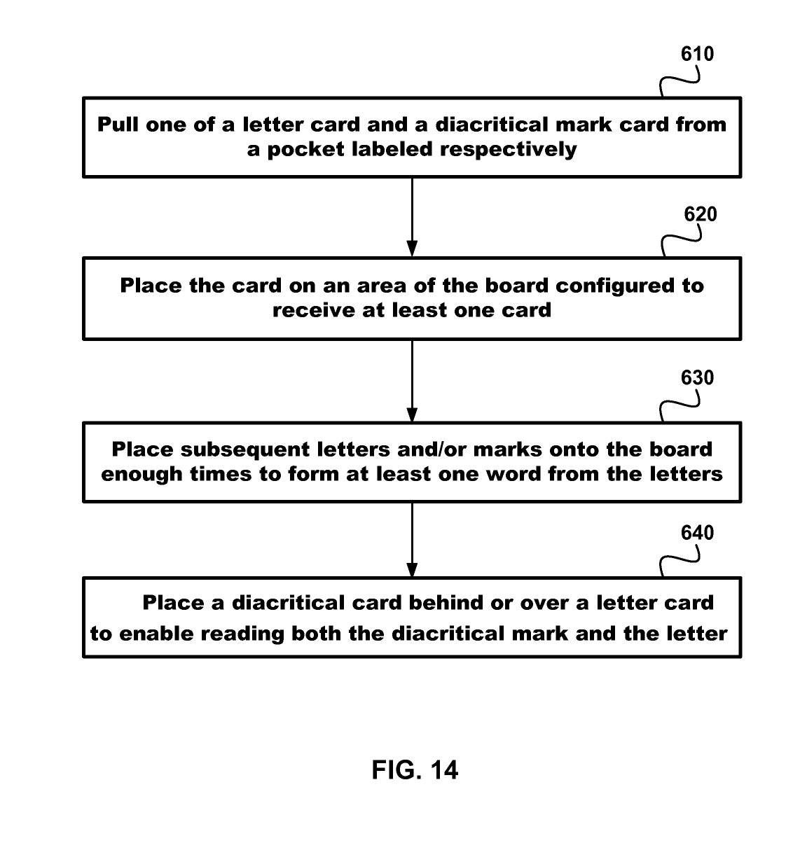

FIG. 14 is a flow chart of a method for learning a language from an alphabet board in accordance with an embodiment of the present disclosure. the method comprises pulling 610 a letter card from a pocket labeled with a specific letter, placing 620 the letter card on an area of the board configured to receive at least one letter and picking and placing 630 a plurality of subsequent letters onto the board enough times to form at least one word from the letters. The method further includes placing 640 a diacritical card behind a respective letter card so that one may read the diacritical mark and the letter at the same time.

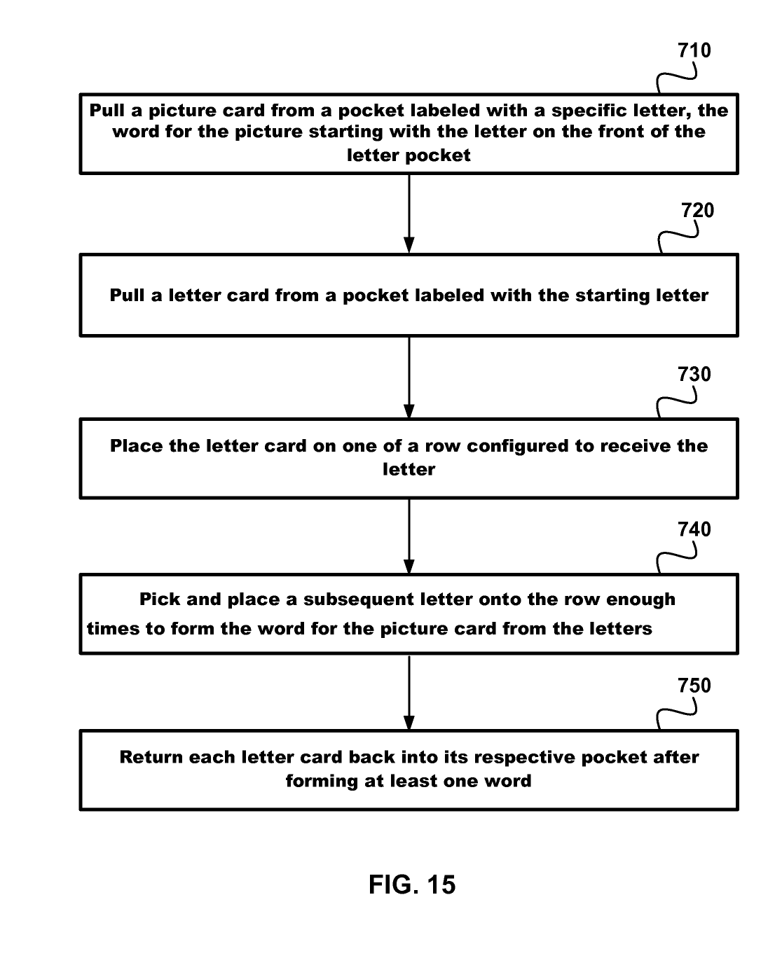

FIG. 15 is a flow chart of a method for forming words and sentences from an alphabet board with picture cards in accordance with an embodiment of the present disclosure. The method may comprise pulling 710 a picture card from a pocket labeled with a specific letter, the word for the picture starting with the letter on the front of the letter pocket. The method includes pulling 720 a letter card from a pocket labeled with the starting letter, placing 730 the letter card on one of a row configured to receive the letter and picking and placing 740 a subsequent letter onto the row enough times to form the word for the picture card from the letters. The method additionally includes returning 750 each letter card back into its respective pocket after forming at least one word. Cards may be returned in alphabetical order to reinforce learning an alphabet's character order.

An embodiment of the disclosed method may include placing the pocket letters onto all the pockets in proper alphabetical order, the pocket letters and the pockets configured to adhere one to another. The method may also include removing at least one pocket letter from the front of the pocket for a random letter to facilitate learning the relative position of a letter in the alphabet. Embodied methods may also include forming words in intersecting rows and columns in a common area on the front side of the board in crossword-like patterns.

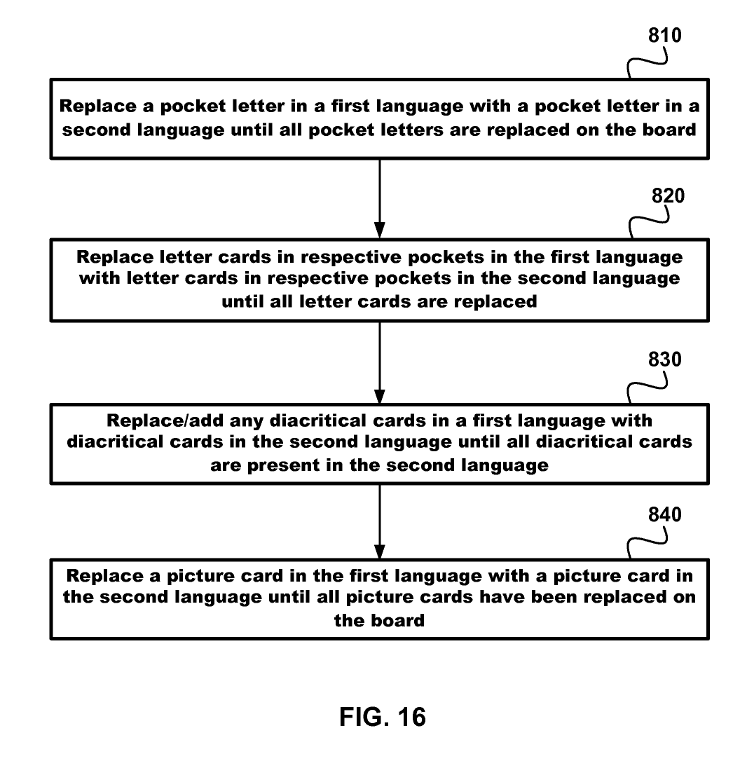

FIG. 16 is a flow chart of a method for transforming an alphabet board in one language into an alphabet board in another language in accordance with an embodiment of the present disclosure. The method includes replacing 810 a pocket letter in a first language with a pocket letter in a second language until all pocket letters are replaced on the board. The method also includes replacing 820 letter cards in respective pockets in the first language with letter cards in respective pockets in the second language until all letter cards are replaced. The method additionally includes 830 replacing or adding any diacritical cards in a first language with diacritical cards in the second language until all diacritical cards are present in the second language. Furthermore, a picture card in the first language may be replaced 840 with a picture card in the second language until all picture cards have been replaced on the board.

The disclosed alphabet board and disclosed methods for learning a chosen language are not to be limited to the languages mentioned herein. Other languages of occidental or of oriental origin may also be learned thereby. Languages employing more than one alphabet such as many oriental languages may use either multiple boards or compound boards as disclosed herein. For instance, the phonetic Korean language may be learned alongside the Hanja or Chinese pictorial character for the respective phonetic letters.

Embodiments of the disclosed board may therefore comprise multiple alphabets on a single compound board, a first alphabet organized on the front side, above or to the left of a common area and a second alphabet organized on the backside, below or to the right of the common area. The compound board facilitates learning multiple alphabets for a common spoken language. For instance, the Japanese use the two phonetic alphabets katakana and hiragana along with Chinese pictographs in their spoken language.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Notwithstanding specific embodiments of the invention have been described and illustrated, the invention is not to be limited to the specific forms or arrangements of parts so described and illustrated. The scope of the invention is to be defined by the claims and their equivalents to be included by reference in a non-provisional utility application.

What is claimed is:

1. A method for learning a language from an alphabet board, comprising:
pulling at least one of a letter card and a diacritical mark card from a pocket labeled with a respective letter and a diacritical mark;
placing the card on an area of the board configured to receive at least one of a letter card and a diacritical mark card; and
picking and placing a plurality of letter cards and diacritical mark cards onto the board enough times to form at least one word from the cards.

2. The method for learning a language from an alphabet board of claim 1, further comprising performing the above steps enough times to make multiple words and a simple sentence comprising at least one card of a plurality of punctuation cards.

3. The method for learning a language from an alphabet board of claim 1, further comprising placing a diacritical card one of behind and over a respective letter card so that one may read the diacritical mark and the letter at the same time, the diacritical mark card comprising one of a transparent material and a non-transparent mark thereon.

4. The method for learning a language from an alphabet board of claim 1, further comprising removing at least one pocket letter from the front of the pocket for a random letter facilitating learning the relative position of a letter in the alphabet during use of the board.

5. The method for learning a language from an alphabet board of claim 1, further comprising forming words in intersecting rows and intersecting columns in a common area on the front side of the board similar to a cross-word like pattern.

6. The method for learning a language from an alphabet board of claim 1, wherein the area configured to receive the letter cards further comprises at least one of a longitudinal slot, a vertical slot and a shelf configured to receive the cards.

7. The method for learning a language from an alphabet board of claim 1, further comprising:
pulling a picture card from a pocket labeled with a specific letter, a word for the picture starting with the letter on the front of the letter pocket;
pulling a letter card from a pocket labeled with the starting letter;
placing the letter card on one of a row configured to receive the letter; and
picking and placing a subsequent letter onto the row enough times to form the word for the picture card from the letters.

8. The method for learning from an alphabet board of claim 1, further comprising returning each letter card back into its respective pocket in alphabetical order after forming at least one word.

9. The method for learning from an alphabet board of claim 1, further comprising a user placing the pocket letters onto all the pockets in proper alphabetical order, the pocket letters and the pockets configured to adhere one to another.

10. An alphabet board system configured to facilitate learning a language, comprising:
a rectangular shaped board comprising a front side and a backside and a hanger disposed on one of the backside and another side;
a plurality of pockets disposed on the front side of the board, each pocket bearing one of a letter in the alphabet and a diacritical mark, the pockets configured to receive a multiple set of cards with one of a card's letter and a diacritical mark matching a respective letter and mark on the pocket;
a plurality of cards for each letter of the alphabet and respective diacritical mark; and
an area on the front side configured to receive and display a plurality of letter cards sufficient to spell a word in the language.

11. The alphabet board system of claim 10, wherein the pocket letter labels are placed from left to right and from top to bottom starting with the first letter of an alphabet and proceeding to the last letter of the alphabet.

12. The alphabet board of claim 10, further comprising a plurality of transparent cards and a plurality of pockets for the transparent cards, the transparent cards configured to bear one of a diacritical mark and a punctuation, the transparent cards configured to overlay a letter card and provide one of a diacritical mark and a punctuation.

13. The alphabet board of claim 10, further comprising a picture card for each letter of the alphabet and at least one area on the board or slot to receive it, the picture card comprising a picture on the front of the picture card and a word for the picture starting with the respective letter printed on the back of the picture card.

14. The alphabet board of claim 10, wherein the board is covered with cloth, a material or a substance, a color of the covering chosen to calm the user of the board and to convey to the user a calm and safe environment for learning.

15. The alphabet board of claim 10, further comprising a set of letter cards in at least one other language, a set of pocket letters in the other language, and a set of picture cards in the other language, the other language comprising one of a plurality of all known languages.

16. The alphabet board of claim 10, further comprising at least one of a longitudinal and a vertical slot and a shelf on the front side of the board, the slot and shelf configured to receive a plurality of cards to form at least one word in the language.

17. The alphabet board of claim 10, further comprising multiple alphabets on a single compound board, a first alphabet organized on one of the front side, above and to the left of a common area and a second alphabet organized on one of the backside, below and to the right of the common area.

18. The alphabet board of claim 10, wherein the pockets and the cards are comprised of a cloth composition, a paper composition, a plastic composition and any other composition having flexibility and memory.

19. A method for transforming an alphabet board in a language, comprising:
replacing a pocket letter in a first language with a pocket letter in a second language until all pocket letters are replaced on the board;
replacing letter cards in respective pockets in the first language with letter cards in respective pockets in the second language until all letter cards are replaced; and
replacing and adding when necessary any diacritical cards in a first language with diacritical cards in the second language until all diacritical cards are present in the second language.

20. The method for transforming an alphabet board in a language of claim 19, further comprising replacing a picture card in the first language with a picture card in the second language until all picture cards have been replaced on the board.
